(19) United States
(12) Patent Application Publication
(10) Pub. No.: US 2010/0215824 A1
(43) Pub. Date: Aug. 26, 2010

(54) COMPOSITIONS SUITABLE FOR FOOD SYSTEMS AND METHODS FOR FORMING THE SAME

(76) Inventors: Frank T. Orthoefer, Germantown, TN (US); John D. Keller, JR., Freehold, NJ (US)

Correspondence Address: Traskbritt, P.C.;Dow Global Technologies Inc., P.O. BOX 2550, SALT LAKE CITY, UT, 84110, US

(21) Appl. No.: 12/711,798

(22) Filed: Feb. 24, 2010

Related U.S. Application Data
(60) Provisional application No. 61/155,087, filed on Feb. 24, 2009.

(51) Int. Cl. A23D 9/007; A23D 9/00

(52) U.S. Cl. 426/546; 426/606

(57) ABSTRACT

The present invention relates to shortening compositions having reduced trans-fatty acids and methods of making the same. Such a shortening composition may include, for example, a mixture of a hard fat and a liquid oil, wherein the liquid oil is a monounsaturated oil. The shortening compositions may be used to make various food products.

### CROSS-REFERENCE TO RELATED APPLICATION

This application is a utility conversion of U.S. Provisional Patent Application Ser. No. 61/155,087, filed Feb. 24, 2009, the entire disclosure of which is hereby incorporated herein by this reference.

### FIELD OF THE INVENTION

The present invention relates to fat products, and more particularly to shortenings containing reduced levels of trans-fatty acids and saturated fats.

### BACKGROUND OF THE INVENTION

Perceptions of the health effects of trans-fatty acids have undergone several changes in recent years. As used herein, the term “trans-fatty acid” means and includes unsaturated fatty acids that contain one or more isolated (i.e., non-conjugated) double bonds in a trans configuration. Trans-fatty acids, which were once heralded as the healthy alternative to saturated fats, have been associated with serious health risks. Epidemiological and experimental studies suggest that trans-fatty acids increase risk more than do saturated fats because they lower serum high density lipoprotein (HDL) cholesterol. Trans-fatty acids have been shown to have adverse effects on blood lipids, to increase inflammatory markers in blood, and to elevate risks of coronary heart disease.

Trans-fatty acids are produced by partial hydrogenation of vegetable oils. This is a process that converts vegetable oils into semisolid fats, which have no known nutritional value. From the perspective of the food industry, partially hydrogenated vegetable oils are attractive because of their long shelf-life, their stability during deep-flying, and their semi-solidity, which can be customized to enhance the palatability of baked goods and sweets. While they occur naturally in meat from cows, sheep, and other ruminants, dietary trans-fatty acids are found primarily in margarines, vegetable shortening, prepared and packaged baked goods, chips and crackers, commercially prepared fried foods, and fast food and restaurant foods.

Solid fats, such as shortenings (i.e., plastic fats) for example, are used in food manufacturing to provide texture and firmness. Shortenings conventionally include saturated fats or oils formed through various processes (e.g., partial hydrogenation) and sources which result in a significant amount of trans-fatty acids in the composition.

With the scientific evidence associating trans-fatty acid intake with an increased risk of coronary heart disease, the U.S. Food and Drug Administration (FDA) issued a final rule that requires the declaration of the amount of trans-fatty acids present in foods, including dietary supplements, on the nutrition label. Mandatory addition of the content of saturated fats and trans-fatty acids to nutrition labels may enable customers to make healthier food choices that may reduce the risk of coronary heart disease and other vascular events.

U.S. Patent Application No. 2008/0199582 discloses shortenings containing low or no trans-fatty acids and low saturates. Specifically, the shortenings include about 11% to about 18% by weight hard fat and about 82% to about 89% by weight liquid oil, said liquid oil having from about 0.1% to about 7% α-linolenic acid based on total fatty acid content. However, polyunsaturated fats, such as linolenic acid, are postulated to results in reduced shelf stability over time.

Based on the serious health implications associated with trans-fatty acid intake, improved shortenings that include reduced trans-fatty acids while retaining a plastic character are desired.

### BRIEF SUMMARY OF THE INVENTION

The following embodiments and aspects thereof are described in conjunction with systems, tools and methods which are meant to be exemplary and illustrative, not limiting in scope. Certain embodiments of the invention include a shortening composition that includes about 15 wt % to about 50 wt % of a hard fat and about 50 wt % to about 90 wt % of a liquid oil comprising a high oleic acid (>70% 18:1) canola oil or a high oleic acid (>80% 18:1) sunflower oil. The hard fat may include at least one of a fully saturated non-hydrogenated cottonseed oil, a cottonseed oil stearine, a fully saturated non-hydrogenated soybean oil, a soybean oil stearine, a fully saturated non-hydrogenated palm oil, a palm oil stearine, a fully saturated non-hydrogenated canola oil, and a canola oil stearine. The liquid oil may further include at least one of canola oil, sunflower oil, safflower oil, and soybean oil. For example, the liquid oil may include various non-hydrogenated monounsaturated oils comprising greater than about 70 wt % oleic acid. Optionally, the composition may include one or more antioxidants such as, for example, tertiary butylhydroquinone (TBHQ), butylated hydroxyanisole (BHA), butylated hydroxytoluene (BHT), citric acid, ascorbic acid, and tocopherol.

Further embodiments include a composition comprising a hard fat comprising at least one of palm oil and palm kernel oil, and a liquid oil comprising a monounsaturated fatty acids. The composition may further include at least one of citric acid, ascorbic acid, butylated hydroxytoluene, and tertiary butylhydroquinone. For example, the composition may include from about 14 wt % to about 25 wt % of the hard fat and from about 75 wt % to about 86 wt % of the liquid oil.

Further embodiments include food products made with, or otherwise comprising, a shortening composition of the present invention. In one embodiment, the shortening composition includes a high oleic canola oil (having greater than about 70% oleic acid) and a hard fat comprising at least one of cottonseed oil, palm oil or soy oil. The food product may be, for example, a cake doughnut mix, raised yeast doughnut mix, sugar cookie mix, frozen biscuit mix, fresh biscuit mix, machined pastry dough, a toaster pastry and an edible product, such as a toaster pastry, that includes the composition.

Further embodiments include methods of making a shortening. Such methods include blending about 5 wt % to about 50 wt % of a hard fat with about 50 wt % to about 90 wt % of a liquid oil comprising omega-9 fatty acids at a temperature sufficient to form a molten mixture, and cooling the molten mixture to crystallize. The crystallized mixture may further be tempered to form a shortening composition having a desired consistency. About 50 ppm to about 200 ppm of one or more antioxidants and/or emulsifiers may be added to the molten mixture. For example, the molten mixture may be formed by heating the components to a temperature of between about 60° C. and about 82.22° C. The molten mixture may be cooled to a temperature of between about 10° C. and about 21.1° C. using a first votator apparatus, may be passed through a back pressure valve to a second votator apparatus where cooling is continued. An inert gas may be fed into the molten mixture, for example, before or during cooling.

Further embodiments include compositions comprising a saturated fat (about 15 wt % to about 25%), starch, such as potato starch (about 2 wt % to about 7 wt %), at least one gum (about 1 wt % to about 5 wt %) and water (about 10 wt % to about 50 wt %) having substantially reduced or eliminated trans fat.

In addition to the exemplary aspects and embodiments described above, further aspects and embodiments will become apparent by study of the following descriptions.

### BRIEF DESCRIPTION OF THE DRAWINGS

FIG. 1 is a schematic representation of an embodiment of a system used to process a shortening composition; and

FIG. 2 is a photograph showing various yellow cake compositions prepared using a conventional shortening and embodiments of shortenings according to the present invention; and

FIGS. 3 and 4 are photographs showing cookies prepared using a conventional shortening composition and embodiments of a shortening composition according to the present invention.

### DETAILED DESCRIPTION OF THE INVENTION

A shortening composition that includes a hard fat and a liquid oil, or other emulsifier (i.e., starch, gums, or water), to create the plastic character without hydrogenation, is disclosed. As used herein, the term “hard fat” means a fully saturated, non-hydrogenated fat. The hard fat component may include hard fats from palm, cottonseed, soy, pure stearic acid and the like, while the liquid oil component may include conventional oils (from olive, sunflower, soy, canola, cottonseed, peanut, etc.) or oils from non-hydrogenated highly monounsaturated fats, such as high oleic acid canola and/or high oleic acid sunflower. In one such embodiment, the liquid oil may comprise an Omega-9® canola oil—a non-hydrogenated canola oil having an oleic acid (18:1) content of about 70 to about 77%, and an α-linolenic acid (18:3) content of less than about 3% (marketed by Dow AgroSciences LLC, Indianapolis, Ind.). In a further such embodiment, the liquid oil may comprise an Omega-9® sunflower oil—a non-hydrogenated sunflower oil having an oleic acid (18:1) content of greater than about 80% and an α-linolenic acid (18:3) content of less than 1% (Dow AgroSciences LLC, Indianapolis, Ind.). The composition may be foimed by mixing the hard fat with the conventional oil or emulsifier to form a flowable mixture. For example, the flowable mixture may be a molten substance that may be crystallized using a cooling device, such as swept surface heat exchangers for super cooling and initiation of crystallization, where such mixture may be held in tempering units for correct crystallization and development. The crystallized mixture may then be extruded for final texture development.

As used herein, the term “trans fat” refers to a type of saturated or partially saturated fat that includes trans-isomer fatty acids.

In some embodiments, the composition may include from about 15% by weight (wt %) to about 50 wt % and, more particularly, from about 18 wt % to about 25 wt % of at least one hard fat component, and from about 50 wt % to about 90 wt % and, more particularly, from about 75 wt % to about 85 wt % of at least one liquid oil. The hard fat component may include, for example, one or more of a non-hydrogenated fully saturated cottonseed oil, cottonseed oil stearine, soybean oil, soybean oil stearine, palm oil, palm oil stearine, canola oil, canola oil stearine, and stearic acid. As a specific non-limiting example, the hard fat may be a high fat composition that includes about 7% whole cottonseed oil and about 3% prilled fatty acids (“Cottonseed HF”). As another non-limiting example, the hard fat may include a palm oil-based product having saturated fat levels in a range of from about 45% to about 48%, a blend of canola oil, palm oil and palm kernel oil having saturated fat levels in a range of from about 20% to about 48%, such as ESSENCE EX36™, ESSENCE 8730™ and ESSENCE 8633™, each of which is commercially available from Aarhus Karlsham AB. Further, the hard fat may include about 20% to about 60%, and more particularly about 48% lauric acid. In yet another non-limiting example, the hard fat may be a fractionated, non-hydrogenated vegetable fat of non-lauric origin, such as a palm kernal oil flakes or powder (i.e., REVEL™A—fractionated, non-hydrogenated, refined vegetable fat derived from palm oil, which is commercially available from Loders Croklaan (Channahon, Ill.)). Such hard fats may have high melting points (the melting point of REVEL™A is 88° C.), an iodine value of about 14, a free fatty acid content of about 0.05% and a trans fatty acid content of less than 1%. For purposes of comparing taste, oxidative stability, and baking utility, the shortening compositions of the present invention may be tested against shortenings made with hydrogenated fats which are typically used in the industry, such as hydrogenated cottonseed oil (e.g., CS100).

The liquid oil may include, for example, one or more of canola oil, sunflower oil, safflower oil, soybean oil, olive oil, cottonseed oil, and peanut oil. It was surprisingly found that a composition including 15% to 25% of a hard fat with a mono-unsaturated oil, such as high oleic canola oil or sunflower oil, achieves unique, enhanced stability over the use of conventional oils. By way of non-limiting example, the liquid oil may include a high level (i.e., greater than about 70%) of mono-unsaturated fatty acids and a low level (less than about 3%) of linolenic fatty acids, such as, for example, Omega-9® canola oil, which is commercially available from Bunge, Canbra and JRI (marketed by Dow AgroSciences, LLC (Indianapolis, Ind.)). The use of such high oleic canola oils are particularly advantageous—having have zero trans fat, the lowest amount of saturated fat and high levels of heart-healthy monounsaturated fat.

Additionally, the composition may include one or more antioxidants or emulsifiers. Suitable antioxidants include, but are not limited to, tertiary butylhydroquinone (TBHQ), butylated hydroxyanisole (BHA), butylated hydroxytoluene (BHT), citric acid, ascorbic acid, tocopherol, and the like. Addition of such an antioxidant to the composition may substantially improve the stability of the composition. Examples of emulsifiers include, but are not limited to plastic mono- and diglycerides, hydrophilic polyglycerol esters (PGE), and propylene glycol monoesters (PGME). As a non-limiting example, the emulsifier may be BFP 65K™ emulsifier or EMPLEX® sodium stearol lactylate (SSL), each of which is commercially available from Caravan Ingredients Inc. (Lenexa, Kans.).

In some embodiments, the composition may include from about 14% of a hard fat and about 86% of a highly mono-unsaturated liquid oil.

In another embodiment, the composition may include a hard fat, at least one starch, at least one gum and, optionally, water to form a plastic fat-like composition that is substantially free of trans fat. The hard fat may be present in the composition in an amount of from about 15% to about 25%. Suitable starches may include, but are not limited to, potato starch, corn starch, wheat starch, rice starch, tapioca starch, sorghum starch, high amylose starches, and the like. By way of non-limiting example, the composition may include from about 2% to about 7% potato starch. Suitable gums include, but are not limited to, xanthan gum, guar gum, carboxymethyl cellulose, carrageenans, alginates, and the like. The composition may include, for example, from about 1% to about 5% of the at least one gum. The composition may further include from about 10% to about 50% water.

The composition may be included in a food product, such as a cake doughnut mix, a raised yeast doughnut mix, a sugar cookie mix, a frozen biscuit mix, a fresh biscuit mix, a laminated dough application, such as puff pastry, croissants and turnovers, and a machined pastry dough, or an edible product or composition, such as a toaster pastry or a fried food. For example, a edible composition may be prepared that includes the composition and may be baked. As another non-limiting example, a fried edible composition may be prepared by providing a food product comprising the composition and flying the food product. In some embodiments, the food product may be fried in the composition.

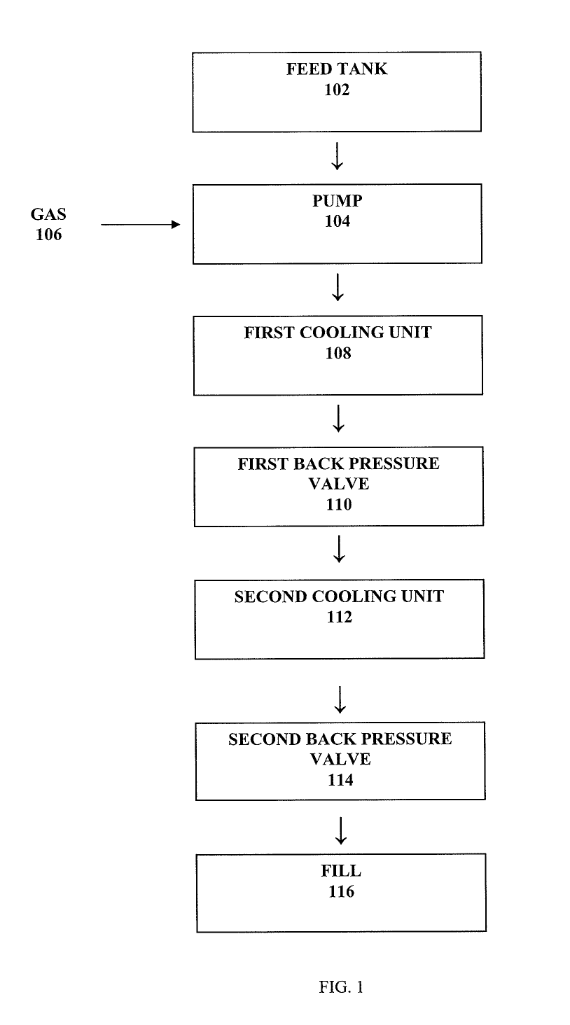

The shortening composition may be pre-formulated into a molten state, cooled, crystallized, tempered and extruded to achieve functionality and plastic character. An embodiment of a system 100 for forming the shortening composition is shown in FIG. 1. For example, from between about 5 wt % to about 50 wt % of the hard fat, from between about 50 wt % to about 95 wt % of the liquid oil and, optionally, from between about 0.1 wt % to about 1 wt % of an emulsifier, and from between about 50 ppm to about 200 ppm of an antioxidant may be combined and liquefied in a feed tank 102 at a temperature greater than a melting point thereof to form a molten composition. For example, the composition may be heated in the feed tank to a temperature of from between about 140° F. (about 60° C.) and about 180° F. (about 8222° C.) and, more particularly, at about 160° F. (about 71° C.). The molten composition may be fed into a first cooling unit 108 using a pump 104 or other similar apparatus. Concurrent gas injection may be used by feeding an inert gas 106, such as air or nitrogen gas (N₂), into the first cooling unit 108 with the molten composition by way of the pump 104. For example, the inert gas 106 and the molten composition may be fed to the first cooling unit 108 while the pump 104 is maintained at a speed of between about 4 RPM and about 8 RPM. The first cooling unit 108 may be, for example, a votator, which is maintained at a speed of between about 5 RPM and about 12 RPM and a temperature of between about 50° F. (about 10° C.) and about 70° F. (about 21.1° C.) to cool the composition. The composition may then be passed through a first back pressure valve 110 to a second cooling unit 112. The second cooling unit 112 may be at a temperature of between about 5 RPM and about 12 RPM and a temperature of between about 60° F. (about 15.6° C.) and about 85° F. (about 29.4° C.) to further reduce the temperature of the composition. Further cooling of the composition is conducted in the second cooling unit 112 to form a cooled composition. Back pressure control units 110 and 114 may be utilized to maintain correct residence time in the first and second cooling units, enabling gradual cooling rates and correct crystal structure formation. For example, the back pressure control units 110 and 114 may be maintained at a pressure of between about 70 psi and about 105 psi. The cooled composition may be extruded or filled using a processing apparatus 116, which may be utilized to temper the composition in controlled temperature environment for final stability.

Table 1 provides particular embodiments of the some representative composition and processing conditions at which the compositions were formed using a system substantially similar to the system 100 described with respect to FIG. 1. In Table 1, the temperature labeled “Feed” refers to a temperature of the feed tank, the temperature labeled as “1” refers to a temperature of the first cooling unit and the temperature labeled as “2” refers to the second cooling unit. The “Back Pressure” is the pressure at which the back pressure control units 110 and 114 were maintained during processing.

TABLE 1

| | | | | Pump | | Temperature | | | Back | | Coolant |
|---|---|---|---|---|---|---|---|---|---|---|---|
| | | | | Speed | | (° F.) | | | Pressure | | Pressure |
| Ingredient | wt % | | grams | 1 | 2 | Feed | 1 | 2 | (psi) | Air | (psi) |
| | | Kg | | | | | | | | | |
| Regular Canola | 86 | 68.25 | | No Data | | | | | | | |
| Cottonseed HF | 14 | 11.11 | | | | | | | | | |
| Omega 9 Canola | 86 | 58.51 | | | | | | | | | |
| Cottonseed HF | 14 | 9.53 | | | | | | | | | |
| Regular Canola | 79.5 | 54.09 | | No Data | | | | | | | |
| Fractionated Palm | 20.5 | 13.95 | | | | | | | | | |
| Oil | | | | | | | | | | | |
| Regular Canola | 79.5 | 54.09 | | | | | | | | | |
| Fractionated Palm | 20.5 | 13.95 | | | | | | | | | |
| Oil | | | | | | | | | | | |
| | | | | | | 140 | 45 | 35 | 95-100 | □ | |
| Omega 9 Canola | 80 | 54.43 | | | | | | | | | |
| Fractionated Palm | 20 | 13.61 | | | | | | | | | |
| Oil | | | | | | | | | | | |
| Regular Canola | 75 | 51.03 | | | | | | | | | |
| Fractionated Palm | 25 | 17.01 | | | | | | | | | |
| Oil | | | | | | | | | | | |
| TBHQ | 200 ppm | | 13.61 | | | | | | | | |
| Omega 9 Canola | 75 | 51.03 | | | | | | | | | |
| Fractionated Palm | 25 | 17.01 | | | | | | | | | |
| Oil | | | | | | | | | | | |
| TBHQ | 200 ppm | | 13.61 | | | | | | | | |
| Regular Canola | 70 | 47.63 | | | | | | | | | |
| Fractionated Palm | 30 | 20.41 | | | | | | | | | |
| Oil | | | | | | | | | | | |
| Omega 9 Canola | 70 | 47.63 | | | | | | | | | |
| Fractionated Palm | 30 | 20.41 | | | | | | | | | |
| Oil | | | | | | | | | | | |
| Regular Canola | 80.1 | 54.85 | | 5.9 | 5.5 | 155 | 59 | 75 | 95-100 | ✓ | |
| REVEL ™ A | 19.9 | 13.61 | | | | | | | | | |
| Omega 9 Canola | 80 | 54.43 | | 5.9 | 6 | 146 | 58 | 80 | 100 | ✓ | |
| REVEL ™ A | 20 | 13.61 | | | | | | | | | |
| Omega 9 Canola | 83.5 | 24.1 | | 6 | 5.5 | 138 | 61 | 70 | 105 | ✓ | |
| REVEL ™ A | 16.5 | 4.75 | | | | | | | | | |
| | | | | 6 | 5.5 | 158 | 66 | 78 | 105 | ✓ | |
| Regular Canola | 83.6 | 24.2 | | | | | | | | | |
| REVEL ™ A | 16.4 | 4.75 | | | | | | | | | |
| Omega 9 Canola | 98 | 66.6 | | 5.9 | 6 | 146 | 73 | 76 | 90-95 | | |
| CS 100 | 2 | 1.36 | | | | | | | | | |
| Regular Canola | 98 | 66.6 | | 5.9 | 5.1 | 153 | 70 | 73 | 100 | | |
| CS 100 | 2 | 1.36 | | | | | | | | | |
| Omega 9 Canola | 80 | 23.10 | | 6 | 5.5 | 166 | 58 | 84 | 105 | ✓ | |
| REVEL ™ A | 19.9 | 5.75 | | | | | | | | | |
| TBHQ | 200 ppm | | 5.75 | | | | | | | | |
| Regular Canola | 80 | 23 | | 6 | 4.5 | 161 | 61 | 86 | 105 | ✓ | |
| REVEL ™ A | 20 | 5.75 | | | | | | | | | |
| TBHQ | 200 ppm | | 5.75 | | | | | | | | |
| Omega 9 Canola | 86 | 24.95 | | 6 | 4.1 | 158 | 62 | 79 | 100 | ✓ | |
| Palm Oil Flakes | 14 | 4.06 | | | | | | | | | |
| Omega 9 Canola | 80 | 112 | | 5.3 | 4.6 | 138 | 58 | 80-85 | 70-90 | 60-80 | |
| REVEL ™ A | 20 | 28 | | | | | | | | | |
| Omega 9 Canola | 80 | 128 | | 5.3 | 4.6 | 138 | 58 | 80-85 | 70-90 | 60-80 | |
| REVEL ™ A | 20 | 32 | | | | | | | | | |
| BHT | 200 ppm | 0.032 | | | | | | | | | |
| Omega 9 Canola | 83.5 | 133.6 | | 5.3 | 4.6 | 138 | 58 | 80-85 | 70-90 | 60-80 | |
| REVEL ™ A | 16.5 | 26.4 | | | | | | | | | |
| BHT | 200 ppm | 0.032 | | | | | | | | | |
| Regular Canola | 80 | 128 | | 5.3 | | 150 | 70 | 75 | 70-90 | max | |
| REVEL ™ A | 20 | 320 | | | | | | | | | |
| BHT | 200 ppm | 0.032 | | | | | | | | | |
| Soybean Oil | 80 | 128 | | 5.3 | 4.6 | 150 | 70 | 75 | 70-90 | max | |
| REVEL ™ A | 20 | 32 | | | | | | | | | |
| BHT | 200 ppm | 0.032 | | | | | | | | | |
| | | lb | | | | | | | | | |
| Omega 9 Canola | 75.6 | 75.6 | | 5.3 | | 150 | 70 | 75 | 70-90 | max | |
| REVEL ™ A | 18.9 | 18.9 | | | | | | | | | |
| BFP 65K | 5.5 | 5.5 | | | | | | | | | |
| | | Lb | | | | | | | | | |
| Omega 9 Canola | 80 | 120 | | 4.5 | 5 | 160 | 70 | 75-85 | 100-105 | 60-80 | 20-30 |
| REVEL ™ A | 20 | 30 | | | | | | | | | |
| Omega 9 Canola | 80 | 60 | | 4.5 | 5 | 160 | 70 | 75-85 | 100-105 | 60-80 | 20-30 |
| REVEL ™ A | 20 | 15 | | | | | | | | | |
| TBHQ | 200 ppm | | 6.8 | | | | | | | | |
| Regular Canola | 80 | 60.00 | | 4.5 | 5 | 160 | 70 | 75-85 | 100-105 | 60-80 | 20-30 |
| REVEL ™ A | 20 | 15.00 | | | | | | | | | |
| TBHQ | 200 ppm | | 6.8 | | | | | | | | |
| Omega 9 Canola | 75.6 | 56.7 | | 4.5 | 5 | 160 | 70 | 75-85 | 100-105 | 60-80 | 20-30 |
| REVEL ™ A | 18.9 | 14.2 | | | | | | | | | |
| Diglyceride | 5.5 | 4.1 | | | | | | | | | |

### Examples

### Example 1

### Preparation of a Yellow Cake including a Shortening Composition

Shortening compositions were prepared that include canola oil and fully saturated cottonseed oil, palm oil and soy oil. A cake composition was prepared that includes between about 22 wt % and about 32 wt % sugar, between about 25 wt % and about 35 wt % flour, between about 10 wt % and about 18 wt % of a shortening composition, between about 0.2 wt % and about 0.6 wt % of an emulsifier, between about 3 wt % and about 14 wt % whole eggs, between about 3 wt % and about 14 wt % milk, between about 0.5 wt % and about 1 wt % of a leavening agent (i.e., baking powder), between about 0.2 wt % and about 0.6 wt % salt, and, optionally, between about 0.2 wt % and about 0.7 wt % of a flavoring. Five (5) different cake compositions were prepared, each including one of Shortenings 1-5. Shortening 1 included a conventional hydrogenated trans-fatty acid-containing shortening composition. Shortening 2 included a high oleic canola oil. Shortening 3 included a mixture of about 86 wt % of a high oleic canola oil and about 14 wt % of a fully saturated cottonseed oil. Shortening 4 included a mixture of about 86 wt % of a high oleic canola oil and about 14 wt % of a fully saturated palm oil. Shortening 5 included a mixture of about 86 wt % of a high oleic canola oil and about 14 wt % of a fully saturated soy oil.

The combinations were found by various subjective (taste panel) and objective evaluation (cake height, cake volume, batter specific gravity and texture analysis) to be substantially similar or substantially superior to cake composition made with trans shortening (Shortening 1).

### Example 2

### Preparation of a Cookie including a Shortening Composition

A chocolate chip cookie dough was prepared by mixing granulated sugar (about 13 wt %), brown sugar (about 12.48 wt %), shortening (about 19.42 wt %), vanilla flavoring (about 0.43 wt %), liquid whole egg (about 8.84 wt)%, salt (about 0.4 wt %), sodium bicarbonate (about 0.33 wt %), flour (about 21.50 wt %) and chocolate chips about (about 23.59 wt %). The cookie dough was prepared using one of three shortening compositions (Shortening A, Shortening B, and Shortening C). The granulated sugar was DOMINO® sugar and the brown sugar was DOMINO® dark brown sugar, each of which is available from Florida Crystals Corp., (West Palm Beach, Fla.). The vanilla flavoring was TONE'S® Imitation Vanilla Extract, which is commercially available from ACH Food Companies (Ankeny, Iowa). The flour was CONAGRA® All-Purpose Flour, which is commercially available from CONAGRA FOODS® (Omaha, Nebr.). Chocolate chip cookie dough was also prepared as described above using Shortening A and Shortening B, but including 25 wt % less shortening (about 14.56 wt %). The densities (g/cc) of the dough compositions are shown in Table 2 below.

TABLE 2

| Shortening System | Dough Density g/cc |
|---|---|
| Shortening C | 1.05 |
| Shortening A | 1.03 |
| Shortening B | 1.03 |
| Shortening A (25% Reduced) | 1.03 |
| Shortening B (25% Reduced) | 1.03 |

Shortening A included a mixture of REVEL™A palm oil flakes and an high oleic acid canola oil (i.e., Omega-9® canola oil), in a ratio of about 20:80, and about 200 ppm tertiary butylhydroquinone (TBHQ). Shortening B included a mixture of REVEL™ A palm oil flakes and a canola oil, in a ratio of about 20:80, and about 200 ppm tertiary butylhydroquinone (TBHQ). Shortening C, which was used as a comparative example, was a commercially available vegetable shortening.

Using a 5 Qt. KITCHEN AID® Mixer (300 Watt Model), the granulated sugar and the brown sugar were combined and pre-blended (5 minutes) to uniformity using a paddle blade stirring attachment at speed 1. The shortening was then creamed with the pre-blended sugars by mixing at speed 2 with paddle stirrer for a timed about (4) minutes, carefully scraping down the sides of the bowl to form a substantially uniform mixture. The liquid whole egg and the vanilla flavor were then combined with the mixture. The shortening blend was creamed, added to the mixture and mixed for about two (2) minutes at speed 1. The sides of the mixing bowl were again scraped down with a spatula to form a substantially uniform mixture. The flour, sodium bicarbonate and salt were added and mixed into the mixture at speed 1 for about one and one-half (1.5) minutes. The chocolate chips were added to the mixture and mixed for 20 seconds at speed 1 with a paddle stirrer. The cookie dough was chilled at refrigeration temperature for 10 minutes to facilitate application onto baking sheets.

Once chilled, the cookie dough was molded onto parchment (i.e., no stick) sheets contained on aluminum baking trays with a 40 g scoop to provide cookies having a set volume application. The cookies were baked at about 400° F. (about 204° C.) in a pre-heated, GE PROFILE® Convection Oven using the center shelf position only to ensure consistent heat exposure for comparison purposes. Cookies containing shortening only were baked for 10 minutes. Observations of cookie spread, browning and chip identity were made during this period and used as a benchmark

Once the baking cycle was complete, cookies were cooled to ambient temperature on wire racks and covered with SARAN® plastic wrap or foil until evaluated or packaged in carefully folded waxed paper subsequently contained in heat sealed foil pouches.

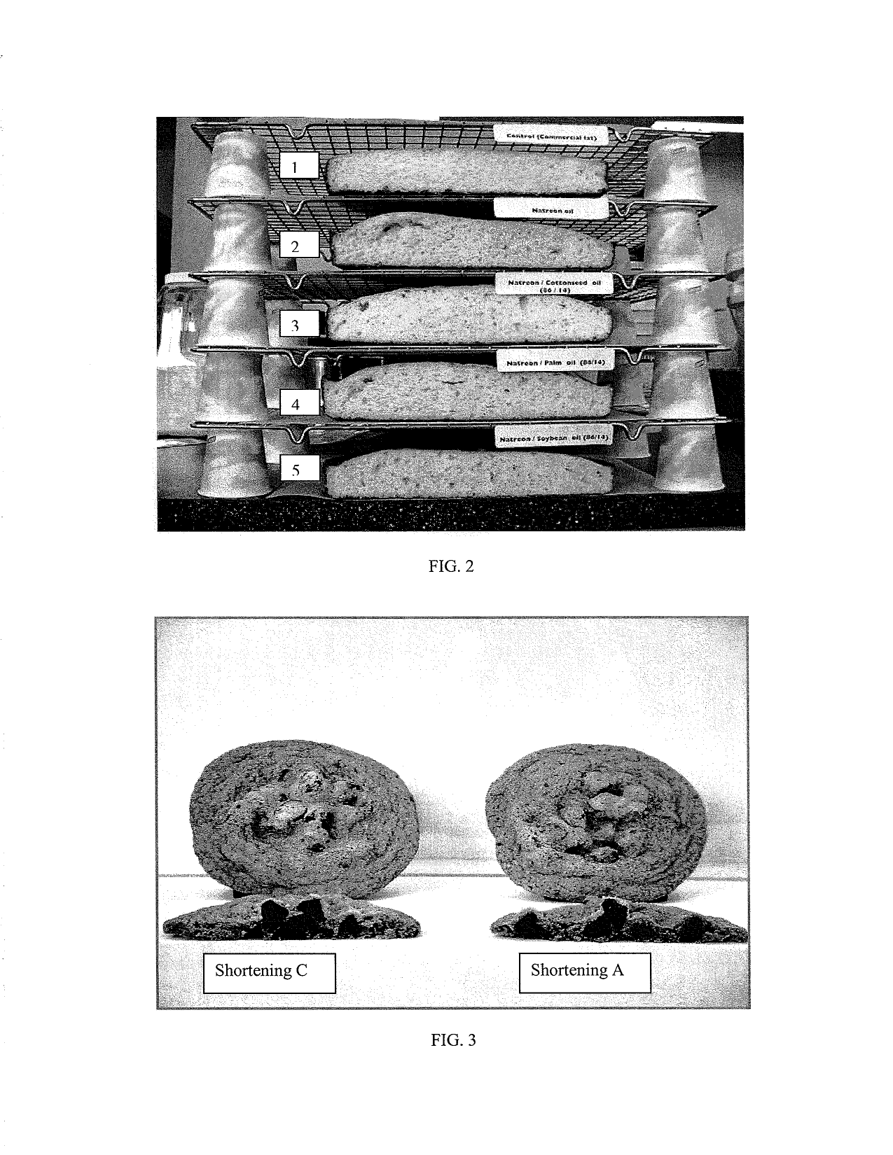

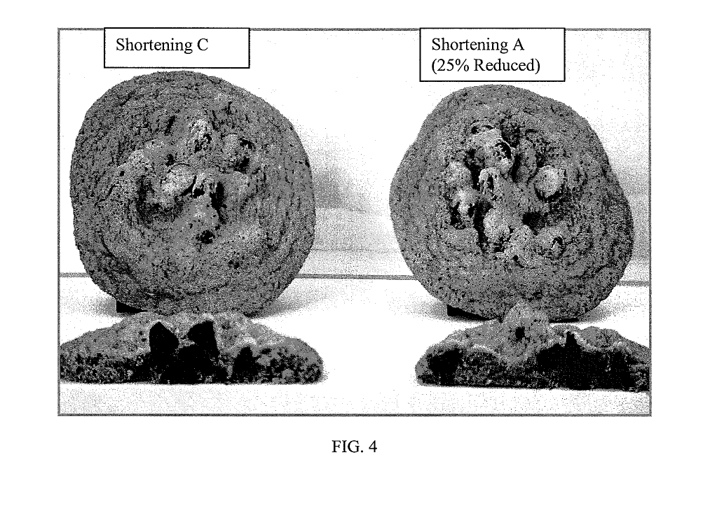

FIG. 3 is a photograph of cookies prepared using Shortening C (comparative example) and Shortening A. FIG. 2 is a photograph of cookies prepared using Shortening C (comparative example) and Shortening A (25% Reduced). As shown in FIGS. 3 and 4, cookies prepared including Shortening A and Shortening B had similar topical appearance, cross-sectional grain appearance and textural qualities to those prepared using Shortening C. Substantially all cookies made from Shortenings A and B handled, processed and appeared much like the conventional shortening (Shortening C). Thus, dough density was used as an index in predicting finished cookie quality and attributes. A comparison of the cost per pound (cost/lb), total fat, trans-fatty acids (trans fat) and saturated fat for each of the shortening compositions tested is provided in Table 3 below.

TABLE 3

| Shortening | | Shortening Data g/serving - 16 g cookie¹ | | |
|---|---|---|---|---|
| System | Cost/lb (fat) | Total Fat | Trans Fat | Sat. Fat |
| Shortening C | 0.7 | 3.10 (4.18) | 0.8 | 0.8 (1.47) |
| Shortening A | 0.89 | 3.10 (4.18) | 0 | 0.71 (1.38) |
| Shortening A | 0.69 | 2.33 (3.41) | 0 | 0.53 (1.20) |
| (25% Reduced) | | | | |
| Shortening B | 0.67 | 3.10 (4.18) | 0 | 0.71 (1.38) |
| Shortening B | 0.52 | 2.33 (3.41) | 0 | 0.53 (1.20) |
| (25% Reduced) | | | | |

As shown in Table 3, both Shortening A and Shortening B (1:1) have substantially reduced saturated fat and substantially reduced or eliminated trans fatty acids in the finished cookies. However, Shortening A may not be as cost effective (1:1) as Shortening B. Use of these materials at a 25% reduced amount further lowers the aforementioned adverse nutritional properties, and additionally, decreases costs of using Shortening A and Shortening B. Shortenings A and B, as well as reduced usages of these materials, were characterized by densities very similar to the control.

While the invention may be susceptible to various modifications and alternative forms, specific embodiments have been shown by way of example in the drawings and have been described in detail herein. However, it should be understood that the invention is not limited to the particular forms disclosed. Rather, the invention encompasses all modifications, variations and alternatives falling within the scope of the invention as defined by the following appended claims and their legal equivalents.

What is claimed is:

1. A shortening composition, comprising:
from about 15 wt % to about 50 wt % of a hard fat; and
from about 50 wt % to about 90 wt % of a non-hydrogenated liquid oil having a fatty acid content of greater than about 70% oleic acid (by weight).

2. The composition of claim 1, wherein the hard fat comprises at least one of a non-hydrogenated fully saturated cottonseed oil, a cottonseed oil stearine, a non-hydrogenated fully saturated soybean oil, a non-hydrogenated soybean oil stearine, a non-hydrogenated fully saturated palm oil, a non-hydrogenated palm oil stearine, a non-hydrogenated fully saturated canola oil, and a non-hydrogenated canola oil stearine.

3. The composition of claim 1, wherein the liquid oil further comprises at least one of canola oil, sunflower oil, safflower oil, and soybean oil.

4. The composition of claim 1, the liquid oil comprises a non-hydogenated canola oil comprising from about 70% to about 77% oleic acid and less than about 3% α-linolenic acid.

5. The composition of claim 1, the liquid oil comprises a non-hydogenated sunflower oil comprising greater than about 80% oleic acid.

6. The composition of claim 1, further comprising at least one antioxidant selected from the group consisting of tertiary butylhydroquinone (TBHQ), butylated hydroxyanisole (BHA), butylated hydroxytoluene (BHT), citric acid, ascorbic acid, and tocopherol.

7. The composition of claim 1, wherein the hard fat comprises cottonseed oil present in an amount of about 14 wt %.

8. The composition of claim 1, wherein the hard fat comprises about 7% whole cottonseed oil and about 3% prilled fatty acids.

9. The composition of claim 1, wherein the hard fat comprises a palm oil-based product having saturated fat levels in a range of from about 45% to about 48%.

10. The composition of claim 1, wherein the hard fat comprises a blend of canola oil, palm oil and palm kernel oil having saturated fat levels in a range of from about 20% to about 48%.

11. The composition of claim 1, wherein the blend of canola oil, palm oil and palm kernel oil is present in the composition in an amount of from about 20% to about 25%.

12. The composition of claim 1, wherein the hard fat comprises about 48% lauric acid.

13. The composition of claim 1, wherein the liquid oil comprises greater than about 70% oleic acid and less than about 3% linolenic fatty acids.

14. A composition comprising:
a hard fat comprising at least one of palm oil and palm kernel oil; and
a liquid oil comprising greater than about 70% monunsatured fatty acids.

15. The composition of claim 14, further comprising at least one of citric acid, ascorbic acid, butylated hydroxytoluene, and tertiary butylhydroquinone.

16. The composition of claim 14, further comprising about 200 ppm tertiary butylhydroquinone.

17. The composition of claim 14, wherein the hard fat comprises from about 14 wt % to about 25 wt % of the composition and wherein the liquid oil comprises from about 75 wt % to about 86 wt % of the composition.

18. A food product comprising a shortening composition, the shortening composition comprising a high oleic canola oil and a hard fat comprising at least one of cottonseed oil, palm oil or soy oil.

19. The food product of claim 18, wherein the high oleic canola oil comprises greater than 70% oleic acid.

20. A method of making a shortening composition, comprising:
blending from about 5 wt % to about 50 wt % of a hard fat with from about 50 wt % to about 90 wt % of a liquid oil comprising greater than about 70% monunsatured fatty acids at a temperature sufficient to form a molten mixture; and
cooling the molten mixture to crystallize.

21. The method of claim 20, further comprises adding from between about 50 ppm to about 200 ppm of at least one antioxidant to the molten mixture.

22. The method of claim 20, further comprises adding from between about 50 ppm to about 200 ppm of at least one emulsifier to the molten mixture.

23. The method of claim 20, wherein said blending from about 5 wt % to about 50 wt % of a hard fat with from about 50 wt % to about 90 wt % of a liquid oil comprising greater than about 70% monunsatured fatty acids at a temperature sufficient to form a molten mixture comprises heating the molten mixture to a temperature of from about 60° C. and about 82° C.

24. The method of claim 20, wherein said cooling step comprises:
cooling the molten mixture to a temperature of from about 10° C. and about 21.1° C. using a first votator apparatus;
passing the molten mixture through a back pressure valve; and
cooling the molten mixture to a temperature of from about 15.6° C. and about 29.4° C. using a second votator apparatus.

25. The method of claim 24, wherein passing the molten mixture through a back pressure valve comprises maintaining the back pressure valve at a pressure of from about 70 psi to about 105 psi.

26. The method of claim 25, further comprising introducing an inert gas into the molten mixture.

27. A shortening composition, comprising:
from about 15 wt % to about 25 wt % of a hard fat comprising a hydrogenated oil;
from about 2 wt % to about 7 wt % of at least one starch; and
from about 1 wt % to about 5 wt % of at least one gum.

28. The shortening composition of claim 27, further including from about 10 wt % to about 50 wt % water.

29. The shortening composition of claim 27, further including at least one antioxidant selected from the group consisting of tertiary butylhydroquinone (TBHQ), butylated hydroxyanisole (BHA), butylated hydroxytoluene (BHT), citric acid, ascorbic acid, and tocopherol.

30. A shortening composition comprising a hard fat component and a non-hydrogenated liquid oil component, wherein said shortening composition is substantially free of trans-fats.

31. The shortening composition of claim 30, wherein said non-hydrogenated liquid oil component comprises greater than about 70% oleic acid.
